(19) United States
(12) Patent Application Publication
(10) Pub. No.: US 2026/0124982 A1
(43) Pub. Date: May 7, 2026

(54) BIFOLD BALCONY FOR DEPLOYMENT FROM A SIDE OF A VEHICLE

(71) Applicant: Lippert Components, Inc., Elkhart, IN (US)

(72) Inventors: Dominic LAYNE, South Bend, IN (US); John SHOTWELL, Edwardsburg, MI (US); Delbert SLABAUGH, Nappanee, IN (US); Lyle MILLER, Nappanee, IN (US)

(21) Appl. No.: 19/383,200

(22) Filed: Nov. 7, 2025

Related U.S. Application Data
(60) Provisional application No. 63/717,478, filed on Nov. 7, 2024.

(51) Int. Cl. B60P 3/34; B60R 3/00; B60S 9/02

(52) U.S. Cl. CPC B60P 3/34; B60R 3/007; B60S 9/02

(57) ABSTRACT

A bifold balcony for deployment from a side of a vehicle includes a balcony floor pivotally connectable at a proximal end to a floor of the vehicle, and a balcony front wall hingedly connected to a distal end of the balcony floor. The balcony floor and the balcony front wall are displaceable between a stowed position, in which the balcony floor and the balcony front wall are substantially planar and fixable in a wall opening of the vehicle, and a deployed position, in which the balcony floor is pivoted from the vehicle floor and in which the balcony front wall is pivoted relative to the balcony floor.

### CROSS-REFERENCES TO RELATED APPLICATIONS

This application claims the benefit of U.S. Provisional Patent Application No. 63/717,478, filed Nov. 7, 2024, the entire content of which is herein incorporated by reference.

### STATEMENT REGARDING FEDERALLY SPONSORED RESEARCH OR DEVELOPMENT

(NOT APPLICABLE)

### BACKGROUND

Recreational vehicles, trailers, and other transportable living or work units often include fold-out or extendable sections to increase usable space when stationary. Traditional fold-out sections such as decks, porches, or ramp doors typically deploy from the rear or side wall of a trailer and provide an exterior platform for outdoor activities or storage. However, most existing designs require extensive manual effort to deploy and retract, rely on bulky support frames or cables, and often lack integrated safety or locking mechanisms to prevent unintended opening during transit.

Moreover, many fold-out platforms are dedicated to a single function, such as loading ramps or rear porches, and do not integrate well into the vehicle's exterior structure when retracted. They may also lack aesthetic or weather-resistant integration, resulting in compromised insulation, appearance, or security.

Accordingly, there is a need for a fold-out balcony system that can be seamlessly integrated into the wall of a trailer or vehicle, that can operate either manually or automatically, and that provides both a protective barrier when deployed and a secure closure when stowed. Such a system should be easy to operate, safe during vehicle motion, and capable of providing an outdoor extension without extensive external assembly or components.

### SUMMARY

The described embodiments are directed to bifold balcony systems for vehicles and trailers, including both manual and automated embodiments. Each system is designed to fold outward from either the rear or side wall of the vehicle, converting a wall section into a deployable balcony structure.

In one embodiment, the wall section includes an upper panel and a lower panel joined by a hinge or folding joint. When the system is in the closed configuration, the upper panel forms a window or transparent portion of the vehicle wall, and the lower panel forms a solid wall portion. When deployed, the lower panel folds outward to form the balcony floor, while the upper panel pivots upward or outward to form a front safety barrier or railing.

The manual version includes handles or grips positioned on the exterior of the wall to enable an operator to pull the balcony open. Bracing arms extend automatically or manually as the balcony unfolds, each having a hard stop or locking feature to maintain the balcony in a horizontal deployed position.

In the automated version, deployment is achieved using a ramp-door style mechanism driven by a powered actuator, such as a back-driven motor, which raises and lowers the panels in a controlled manner. The automated system may include a control unit, limit switches, or sensors for synchronized operation and safety.

Both versions may include locking bars or latches that are manually or automatically engaged from the exterior to prevent accidental opening during vehicle motion. Additionally, a tensioned folding cable system or other collapsible side-barrier mechanism may be provided to form protective side railings when the balcony is in use.

The described bifold balcony systems thus offer compact integration, ease of use, and improved safety, providing both functional and aesthetic benefits over conventional fold-out platforms.

In an exemplary embodiment, a bifold balcony for deployment from a side of a vehicle includes a balcony floor pivotally connectable at a proximal end to a floor of the vehicle, and a balcony front wall hingedly connected to a distal end of the balcony floor. The balcony floor and the balcony front wall are displaceable between a stowed position, in which the balcony floor and the balcony front wall are substantially planar and fixable in a wall opening of the vehicle, and a deployed position, in which the balcony floor is pivoted from the vehicle floor and in which the balcony front wall is pivoted relative to the balcony floor.

The balcony floor may be opaque. The balcony front wall may include a window pane that allows light into the vehicle in the stowed position.

In some embodiments, the bifold balcony may include a frame jamb positionable in the wall opening of the vehicle, and in the stowed position, the balcony floor and the balcony front wall engage the frame jamb. In this context, a seal may be provided between the frame jamb and the balcony floor and between the frame jamb and the balcony front wall. Rotating arm locks may be actuatable from hinges connected to the frame jamb. The balcony may include a pair of catches disposed on an underside of the balcony floor, where the rotating arms locks are respectively engageable with the catches when the balcony floor and the balcony front wall are in the stowed position. A handle may be disposed on an underside of the balcony floor. The frame jamb may include side jambs, and the bifold balcony may further include a two-piece folding brace arm including a jamb portion pivotally connected adjacent the side jambs, and a balcony portion pivotally connected to the balcony floor. In this context, the jamb portion and the balcony portion may be pivotally connected to each other.

In some embodiments, side barriers may be disposed between the balcony front wall and the frame jamb in the deployed position. In this context, each of the side barriers may include a top rail pivotally connected to the frame jamb such that the top rails are pivotable between a vertical retracted position when the balcony floor and the balcony front wall are in the stowed position and a horizontal extended position when the balcony floor and the balcony front wall are in the deployed position. Each of the side barriers may further include a plurality of spring-loaded cables connected between the frame jamb and the balcony front wall.

The bifold balcony may include a motor-driven actuation system positioned within the frame jamb and acting on the balcony floor and the balcony front wall to displace the balcony floor and the balcony front wall between the stowed position and the deployed position.

The balcony front wall may include a fixed section and a door section pivotally connected to the fixed section, where the door section is pivotable relative to the fixed section between a closed position and an open position. A step assembly may be attachable to a forward portion of the balcony floor in alignment with the door section. The balcony may include stabilizer legs connected to an underside of the balcony floor.

In another exemplary embodiment, a bifold balcony system positionable in a vehicle opening includes a frame jamb securable in the vehicle opening, and a balcony frame including a balcony floor pivotally connectable at a proximal end to a floor of the vehicle and a balcony front wall hingedly connected to a distal end of the balcony floor. The balcony floor and the balcony front wall are displaceable between a stowed position, in which the balcony floor and the balcony front wall are substantially planar and fixable in the frame jamb, and a deployed position, in which the balcony floor is pivoted from the vehicle floor and in which the balcony front wall is pivoted relative to the balcony floor. Side barriers are disposed between the balcony front wall and the frame jamb in the deployed position.

### BRIEF DESCRIPTION OF THE DRAWINGS

These and other aspects and advantages will be described in detail with reference to the accompanying drawings, in which:

FIG. 1 shows the bifold balcony frame in a fully stowed position;

FIG. 2 shows the bifold balcony frame in a fully deployed position;

FIGS. 3A-C show exemplary details for tensioned cables as part of the side barriers;

FIGS. 4-6 show the balcony frame as it is unfolded and deployed;

FIG. 7 is a close-up view of the balcony hinge at the midline of the balcony frame;

FIG. 8 is a close-up view of the floor hinge of the balcony frame;

FIG. 9 shows a sealing system around the jam for engaging peripheral flanges of the bifold balcony frame;

FIG. 10 shows the connection of an actuation system cable to the balcony floor for a motorized version of the bifold balcony;

FIGS. 11 and 12 show an automated latch internal to the jam for locking the bifold balcony frame in the stowed position;

FIGS. 13-16 show a variation including a door section in the balcony front wall and a step assembly;

FIG. 17 shows a variation with the step assembly secured to the balcony floor in the deployed position;

FIG. 18 shows the variation of FIG. 17 with the step assembly and the bifold balcony in the stowed position; and

FIGS. 19-24 show variations and features of the bifold balcony.

### DETAILED DESCRIPTION

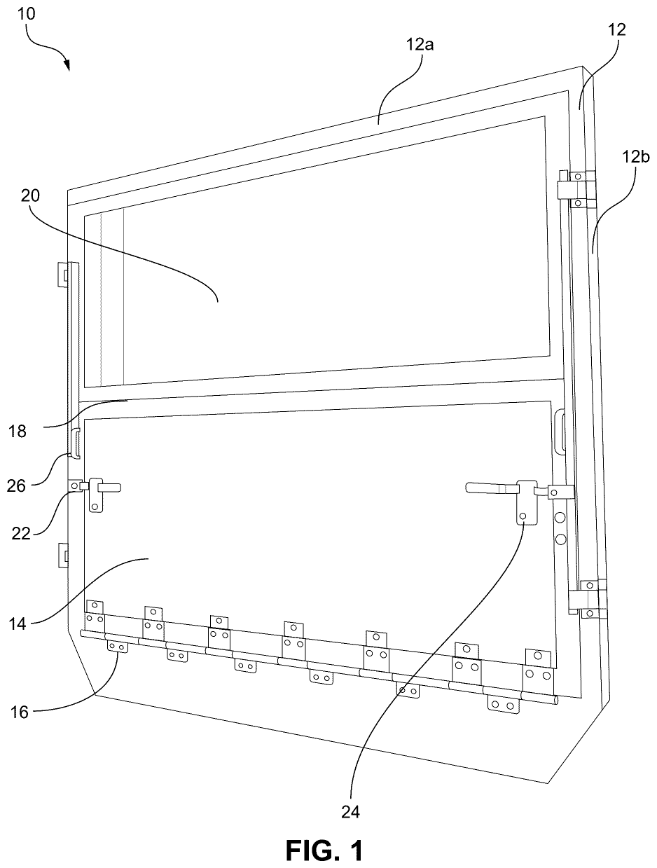

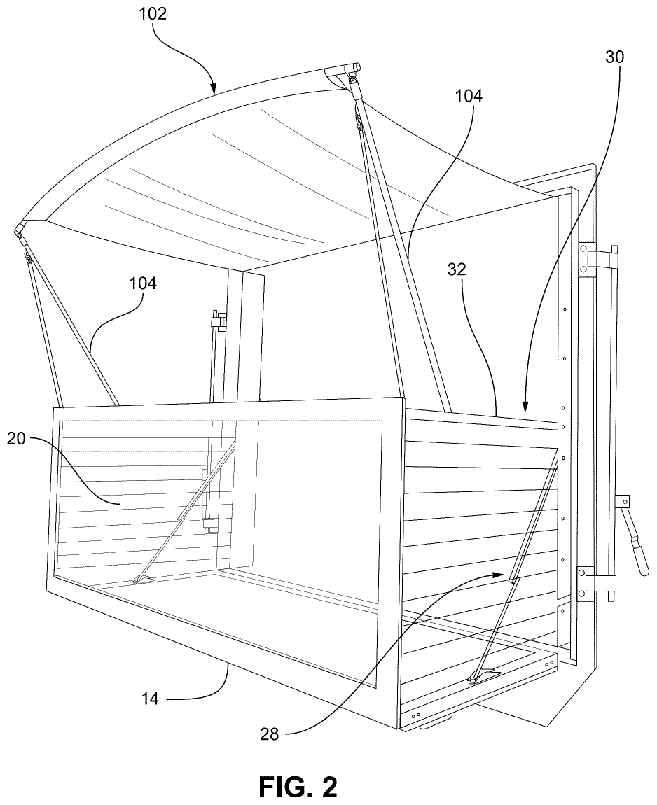

FIGS. 1 and 2 show a manual version of the bifold balcony including a bifold balcony frame 10 in a fully stowed position and a fully deployed position, respectively.

A frame jamb or hoop 12 encloses a wall opening with the vehicle floor. The bifold balcony frame 10 fully closes the wall opening within the jamb 12 in the stowed position (FIG. 1).

The proximal end of the bifold balcony includes a balcony floor portion 14 that is connected to the structure floor via a hinge 16. The balcony floor portion 14 may be opaque. A midline of the bifold balcony frame includes a balcony hinge 18 that separates the balcony floor portion 14 and a balcony front wall portion 20. The balcony front wall portion 20 may generally be a transparent window pane that allows light into the trailer or vehicle in the stowed position. In variations, the balcony floor portion 14 could alternatively be transparent, and the balcony front wall portion 20 could alternatively be opaque. That is, the balcony floor portion 14 and the balcony front wall portion 20 can be either of a transparent window panel or an opaque structural panel.

A distal end of the bifold balcony frame 10 generally is the upper ledge of the bifold balcony front wall portion 20 that engages a top beam 12a of the jamb 12 in the fully stowed position.

Rotating arm locks are actuatable from hinges connected to side beams 12b of the jamb 12 and can rotate a locking arm 22 to engage a catch 24 on the outer face (underside when deployed) of the bifold balcony floor portion 14 when the balcony is fully closed or stowed. The user-actuated arm locks are accessible from the outside of the assembly and lock the balcony frame 10 in the stowed position so that the balcony frame 10 is prevented from opening or deploying during an undesired time, such as when the trailer or vehicle is in motion. The locking arms 22 prevent unlocking due to vibration while the vehicle is in motion.

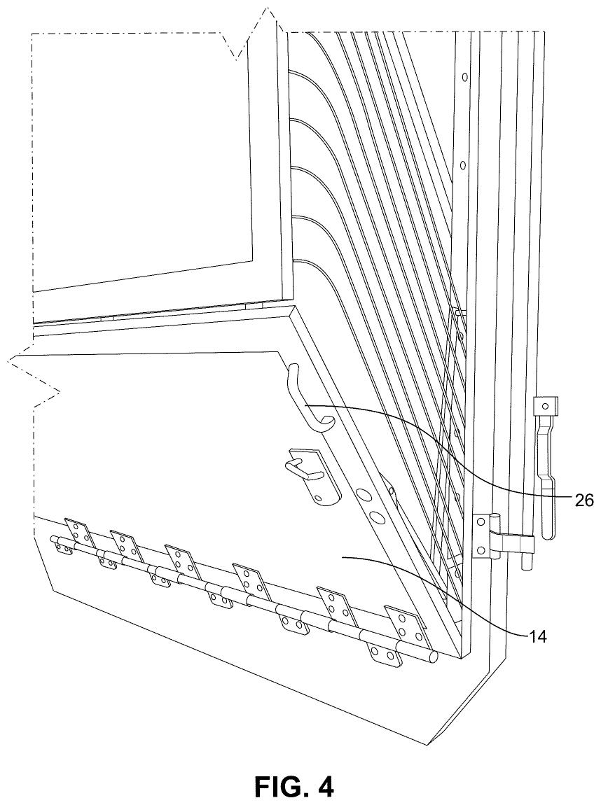

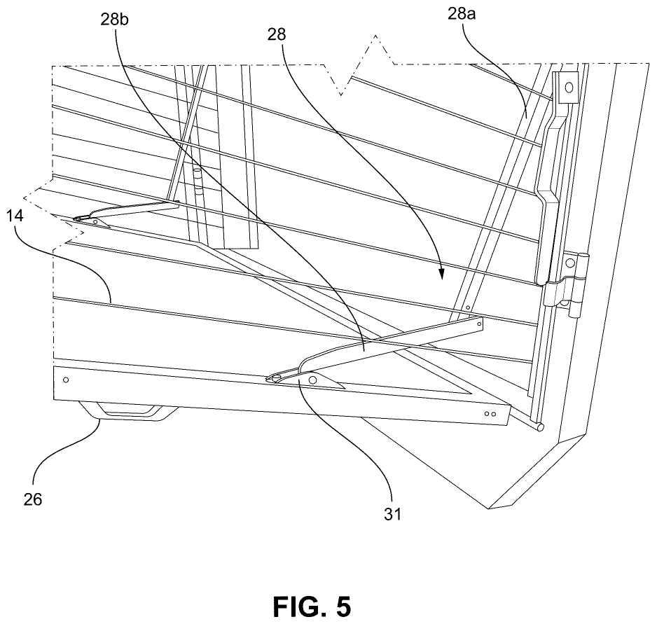

FIGS. 4-6 show the manual bifold balcony frame 10 as it is unfolded and deployed. When the rotating locking arms 22 at the sides of the bifold balcony are pivoted to the unlocked position, a user can grab a handle 26 disposed on the exterior of the bifold balcony frame 10 (on an underside of the balcony floor portion 14 as shown) to begin to open and pivot the frame 10 outwards towards the deployed position. As shown in FIG. 2, the assembly may be provided with a retractable awning 102 including support arms 104 connected to the top rails 32.

A two-piece folding brace arm 28 has a jamb portion 28a pivotally connected near a midpoint of an internal channel in both side jambs 12b. A balcony portion 28b of the brace arm 28 is pivotally connected to a mount 31 on the interior surface of the bifold balcony floor portion 14 on or near the side edges of the frame 10. The jamb portion 28a and balcony portion 28b of the brace arm 28 are pivotally connected to each other at their opposite ends.

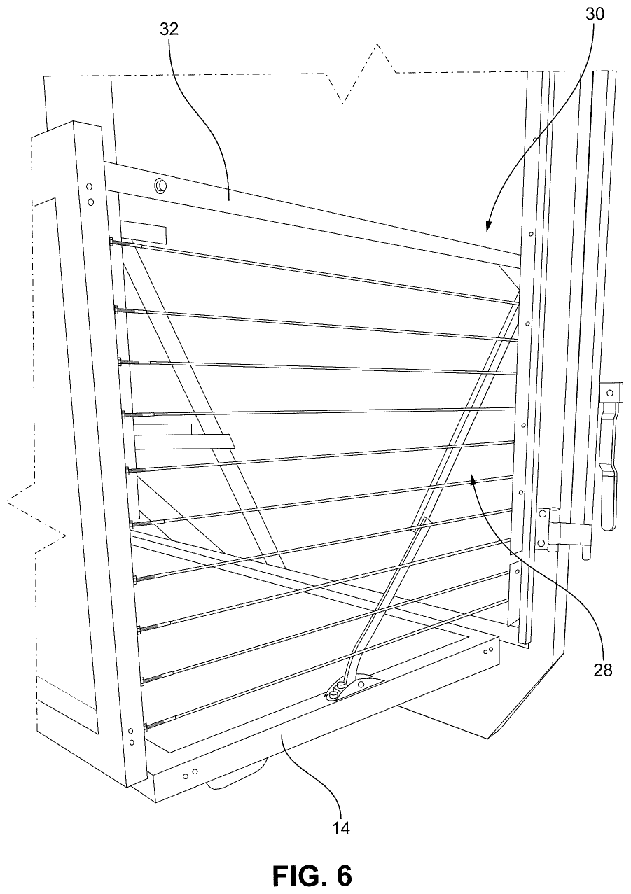

When stowed, the portions of the brace arm 28 move away from each other to unfold towards the deployed position. In the deployed position, the portions of the brace arm 28 are generally colinear to support the balcony frame 10 in the deployed position and to brace against movement past the deployed position with the balcony floor portion 14 in a generally horizontal orientation (see FIG. 6).

With reference to FIGS. 2 and 6, a side barrier 30 on each side of the bifold balcony frame 10 includes a top rail 32 pivotally connected near a midpoint of the side jamb 12b. The distal ends of the top rails 32 of the side barrier 30 are pivotally connected near a distal end of the bifold balcony frame 10 and therefore pivot downward out of an internal channel of the side beam or jamb 12b. The pivot connection to the bifold balcony frame 10 may include an arm projecting perpendicularly from the balcony front wall portion 20 so that the pivot point is offset from the bifold balcony frame 10 to prevent binding during actuation. In the fully deployed position, the top rails 32 are horizontal and help brace the bifold balcony frame 10 from pivoting below the deployed balcony position.

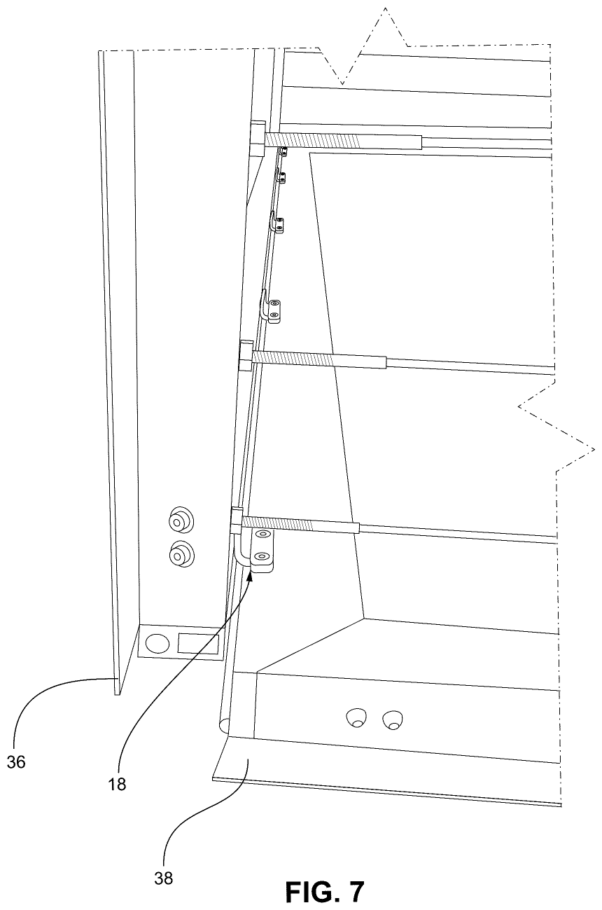

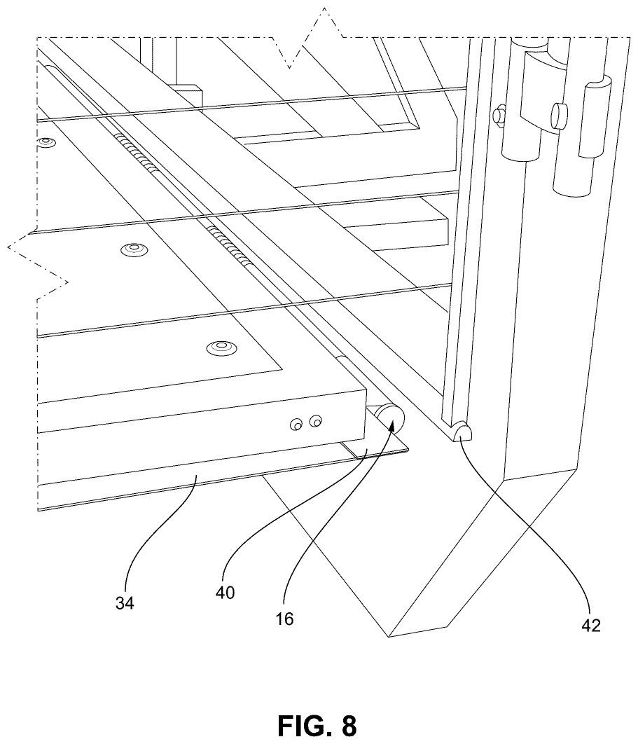

FIGS. 7 and 8 provide a closer view of the balcony hinge 18 at the midline of the balcony frame 10 and the floor hinge 16 of the balcony frame, respectively. The balcony front wall portion 20 and the balcony floor portion 14 of the bifold balcony may be connected with hinges on the interior frame edges of the panels.

A periphery of both panels may be made of frame extrusions that encapsulate the outer edges of both panels, and a sealing flange 34 may extend from the exterior side of the frame extrusions. The bottom frame extrusion of the balcony front wall portion 20 includes an extended closing flange 36 to overlap the upper frame extrusion of the balcony floor portion 14 for sealing purposes and to mitigate a pinch point in the frame. The top frame extrusion of the balcony floor portion 14 may not include a flange, but instead may include a rubber bumper or seal 38 to prevent damage at the balcony hinge 18 and to preclude water or dust entrapment at the balcony hinge.

The bottom frame extrusion of the balcony floor portion 14 includes an extended flange 40 that is connected to the floor hinge 16 of the balcony frame 10 to position the bifold balcony frame 10 within the structure opening when in the stowed position. A seal 42 may be disposed adjacent and interior to the position of the floor hinge 16 on the structure wall to compress with the flange 40 and preclude water or dust entrapment.

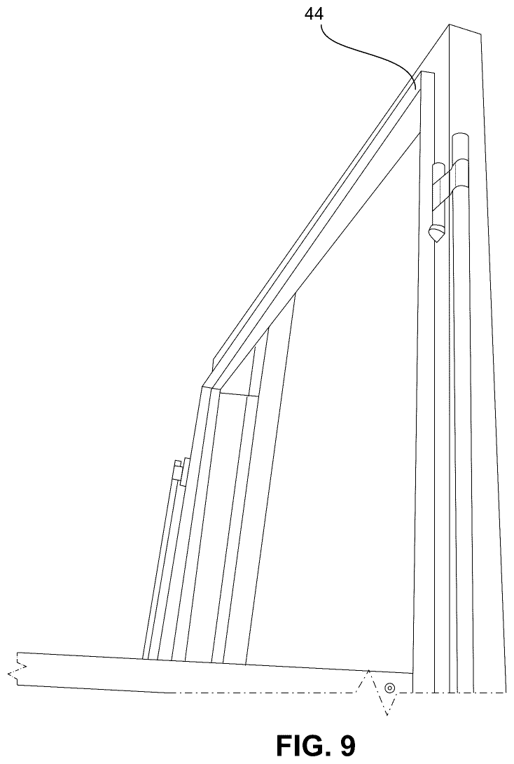

FIG. 9 shows a sealing system 44 around the jamb 12 for engaging the peripheral flanges of the bifold balcony frame 10. This sealing system 44 also serves to protect the balcony frame 10 from damage as it is stowed and to preclude water or dust entrapment within the assembly.

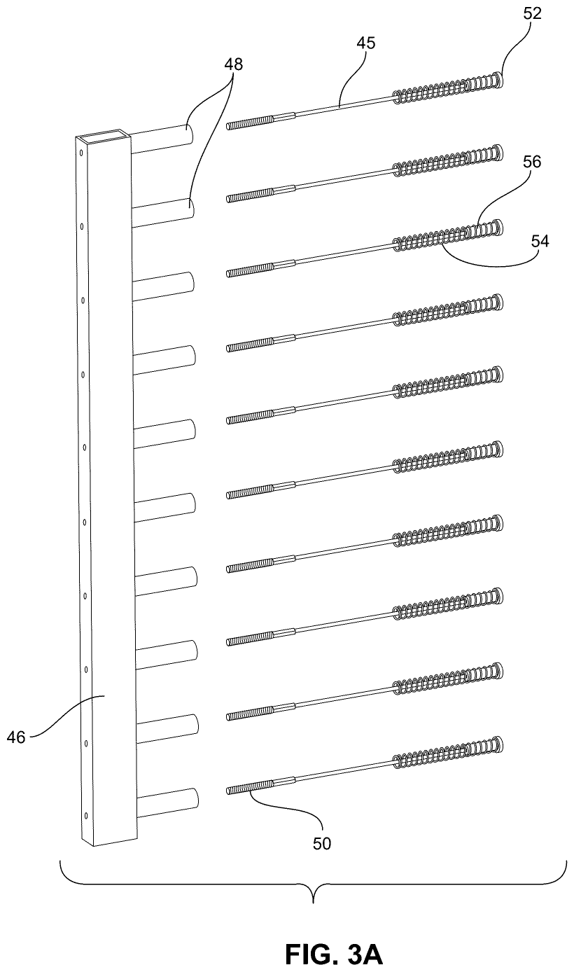

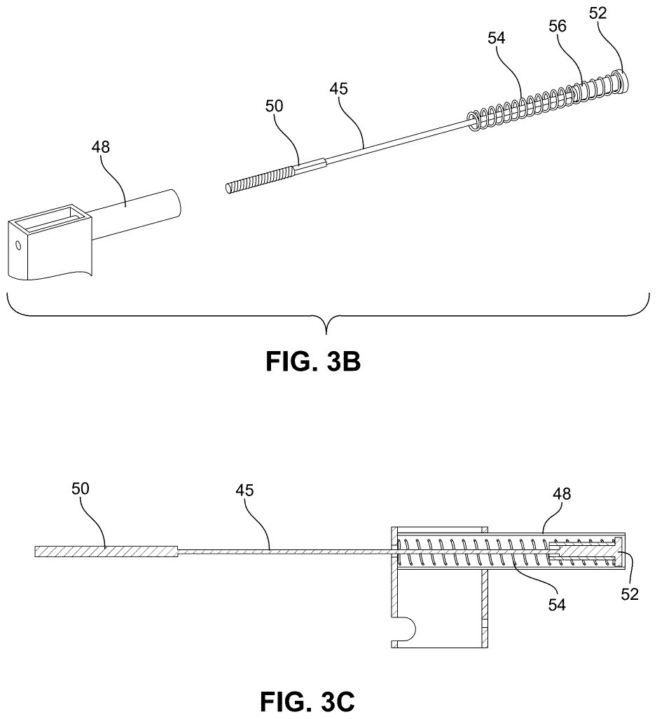

FIGS. 3A-C show exemplary details for tensioned cables 45 as part of the side barrier 30. Within the internal channel of both side jambs 12b mounts a base 46 including multiple guide tubes 48. A threaded cable end 50 is inserted through each guide tube 48, through the base 46, and is attached to the interior surface of the balcony front wall portion 20 along the side frames via a fastener. The cable 45 is retained in the guide tubes 48 and base 46 with a cable 52 end that is larger in diameter than the guide tube 48. A spring 54 is fixed with the interior side of the cable end 52 and extends over a cable hard stop 56 and over part of the cable 45.

As the bifold balcony frame 10 is opening and is moved toward the deployed position, the spring 54 pushes against a surface of the base 46 to tension the cables 45 while the balcony frame 10 is transitioning. This keeps the cables 45 tensioned enough to not tangle or have enough slack to get caught in the deployment arms of the top barrier rail 32 or the brace arm 28.

In the fully deployed position, the springs 54 are fully compressed with the cables 45 fully extended to remain tensioned. The cable tensioning springs 54 also bias the cables 45 toward the stowed position and may assist in the stowing transition of the bifold balcony frame 10.

The bifold balcony frame 10 may be deployed manually as described above or may alternatively include a motor and cables for motorized deployment. The powered bifold balcony mostly actuates the same way as the manual version and has most of the same features. The powered version houses a motor-driven actuation system within the side jambs 12b. An exemplary motor-driven actuation system is described in U.S. Patent Publication No. 2023/0202373 directed to a “Power door jamb ramp door,” the contents of which are hereby incorporated by reference.

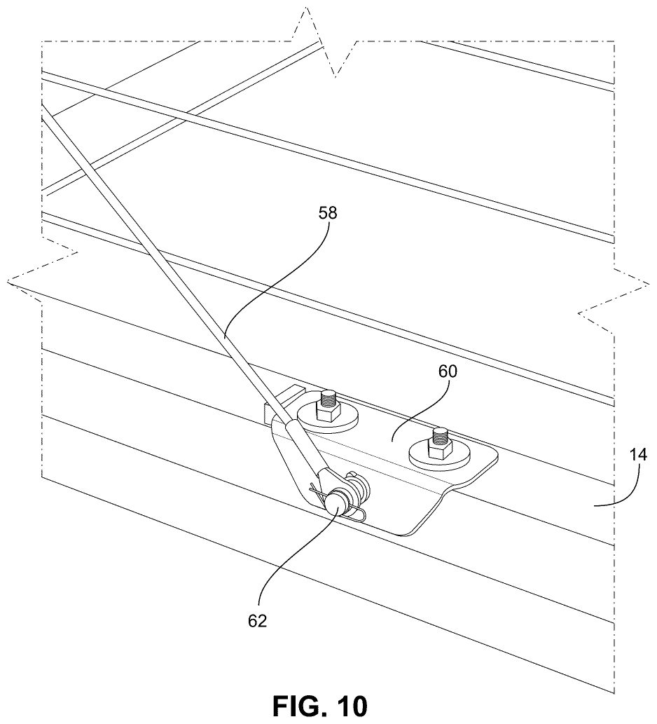

The drive system may include the addition of a back-driven motor for prevention of movement or shifting of the balcony out of position once in the deployed position. The back-driven motor also creates a mechanism that can be manually deployed or stowed in the event of power failure. FIG. 10 shows the connection of an actuation system cable 58 to the balcony floor portion 14. The actuation system cable 58 extends down from the actuation system within the side jambs 12b of the structure through an aperture in the outer face of the side jambs. The actuation cable 58 is connected to a mount 60 on the side extrusions of the balcony floor portion 14 via a fastener or pin 62. The actuation system stows with the actuation cable 58 being mostly disposed within the side jamb 12b, and the actuation cable mount 60 is pulled up and inward to be adjacent to the side jamb 12b in the fully stowed position.

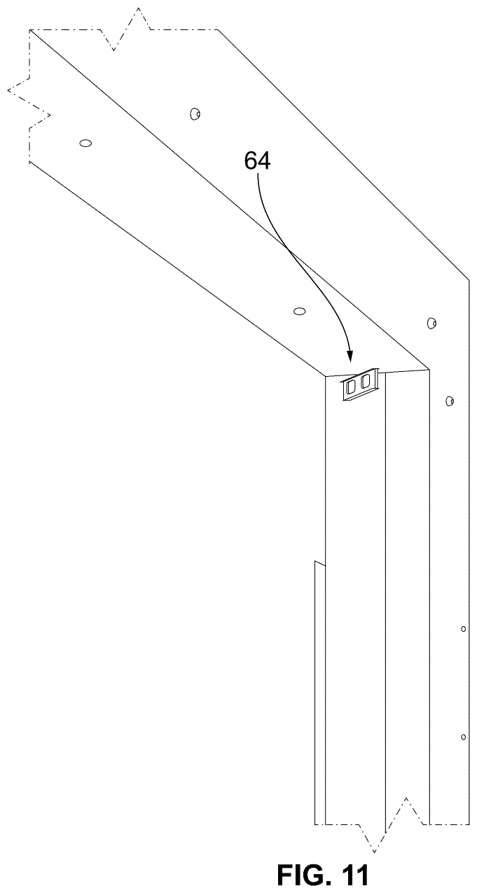

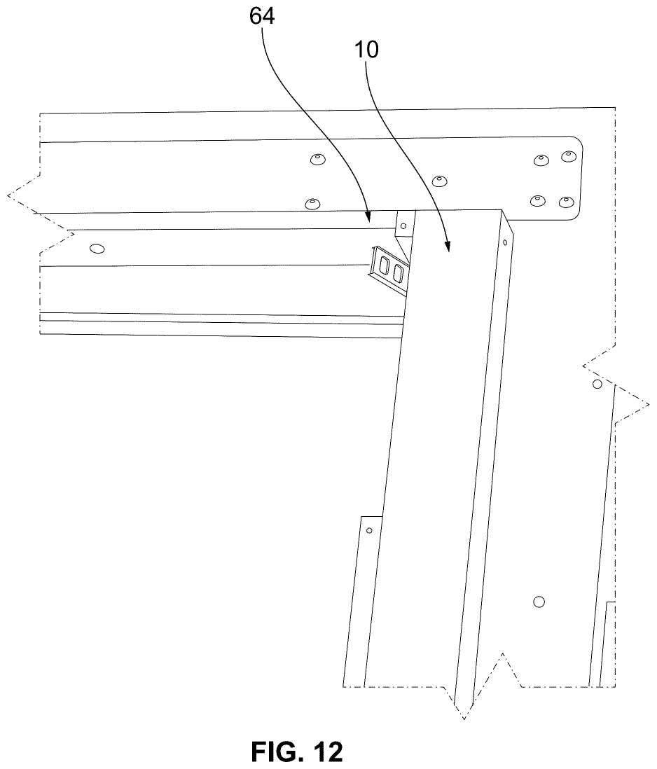

FIGS. 11 and 12 show an automated latch 64 internal to the jamb 12 for locking the bifold balcony frame 10 in the stowed position once fully closed.

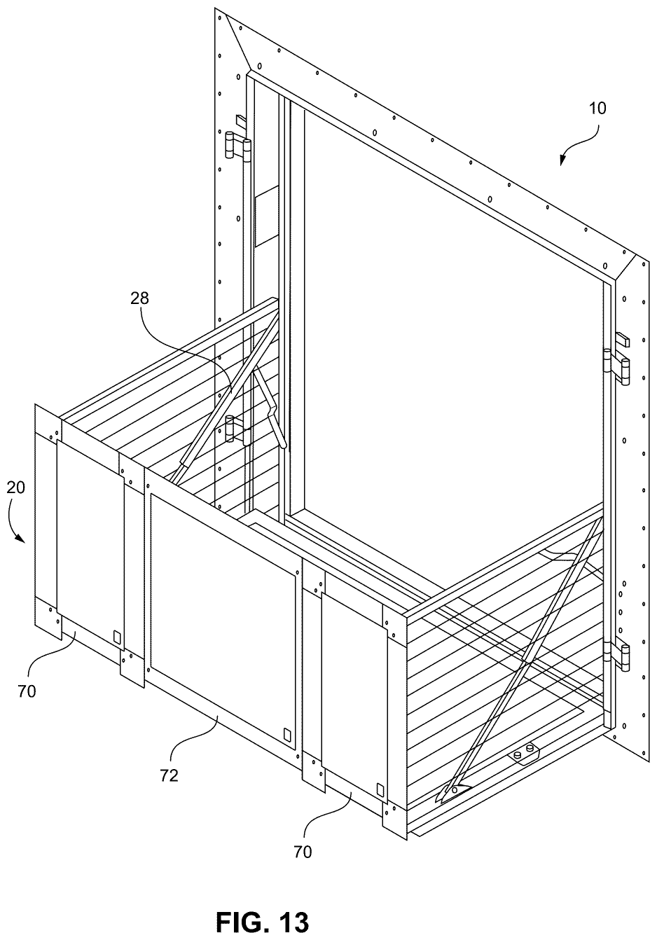

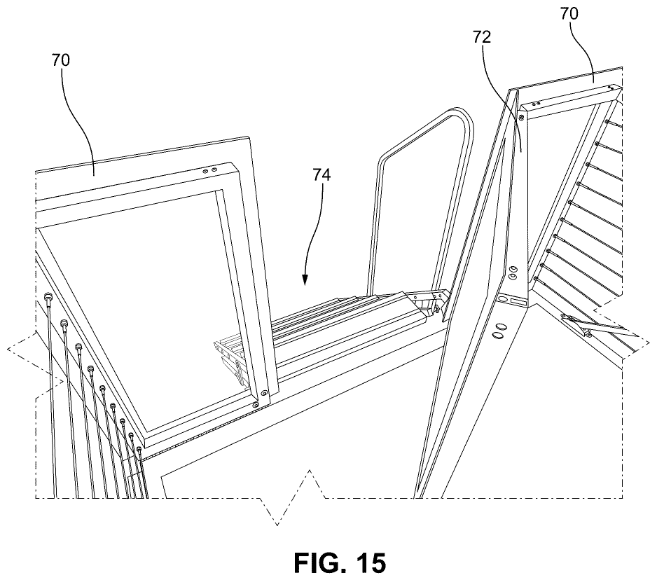

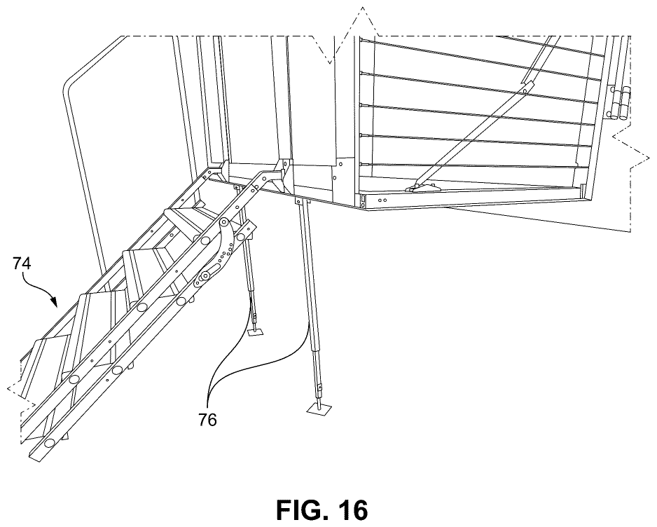

FIGS. 13-16 show a variation where the balcony front wall portion 20 includes a door section 72 positioned in alignment with a step assembly 74 for entry and exit. In this embodiment, the balcony front wall portion 20 includes one or more fixed sections 70 and the door section 72 pivotally connected to one of the fixed sections 70. The door section 72 is pivotable relative to one of the fixed sections 70 between a closed position and an open position. A roller may be provided under the door section 72 to facilitate displacement between the closed and open positions. The step assembly 74 is attachable to a forward portion of the balcony floor portion 14 in alignment with the door section 72. The door section 72 could alternatively be disposed about one of the sides or outer edges at the top half of the frame.

In some embodiments, the door section 72 is a larger portion of the top half of the frame 10 for generally providing a larger exit that is a similar size to the step assembly 74. Any suitable latching system for the door may be used, including mechanical latches, magnetic latches, etc. The step assembly 74 is conventional and is preferably detachably secured to the balcony floor portion 14. The step assembly may be provided with adjustable leg extensions to accommodate varying ground heights.

In some embodiments, outer faces of the frame extrusions of the fixed sections 70 and the door section 72 or components of the top half of the frame are designed to be overlapping in the closed door position, but the bottom of the door section 72 does clear the hinge to swing open inwardly to the deck. Like the first embodiment, outer flanges of the top half of the frame also overlap with the outer face of the jamb or vehicle opening when the assembly is in the stowed position. A seal may be provided between the frame and the jamb for water and dust exclusion.

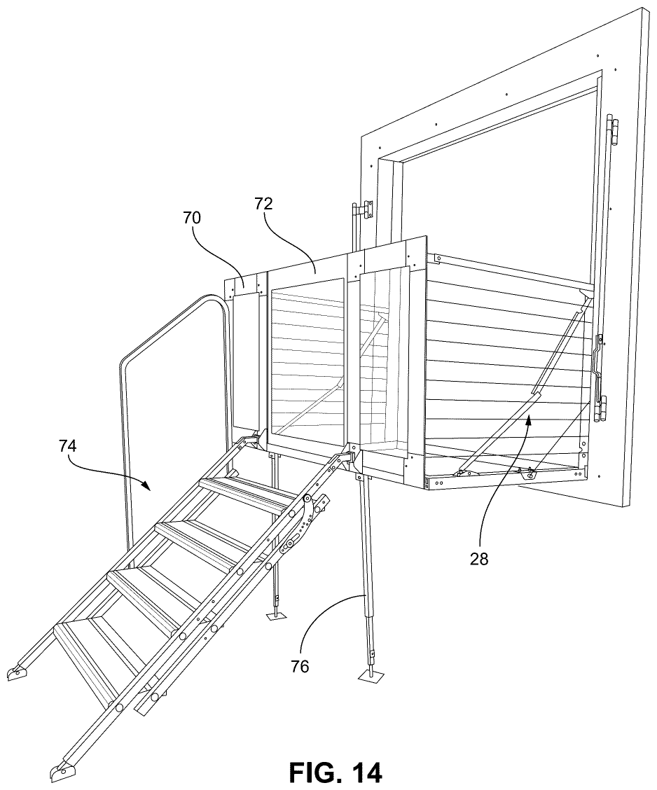

With continued reference to FIG. 14, the assembly may also be provided with one or more detachable stabilizer legs 76. The legs 76 provide extra support below the entry door and step assembly. The stabilizer legs 76 may be telescopic to accommodate varying ground height. Additionally, the stabilizer legs 76 may be positioned at other locations under the balcony floor portion 14.

In some embodiments, the window frame portions of the top half of the bifold balcony frame may include a channel for integration of a sliding or selectively deployable shade. In some embodiments, a retractable screen door system may be integrated within the vehicle opening for use when the balcony is deployed.

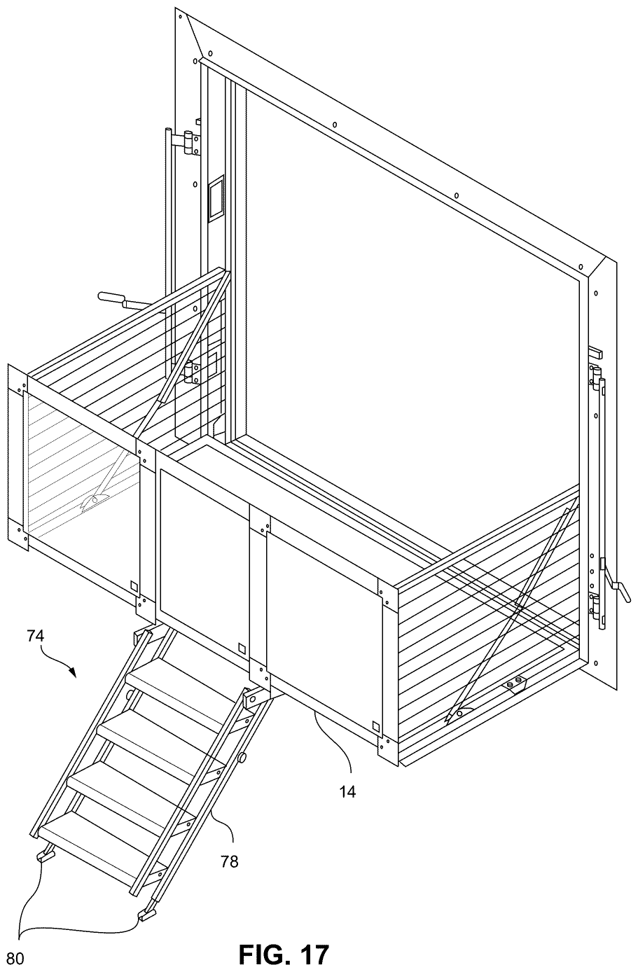

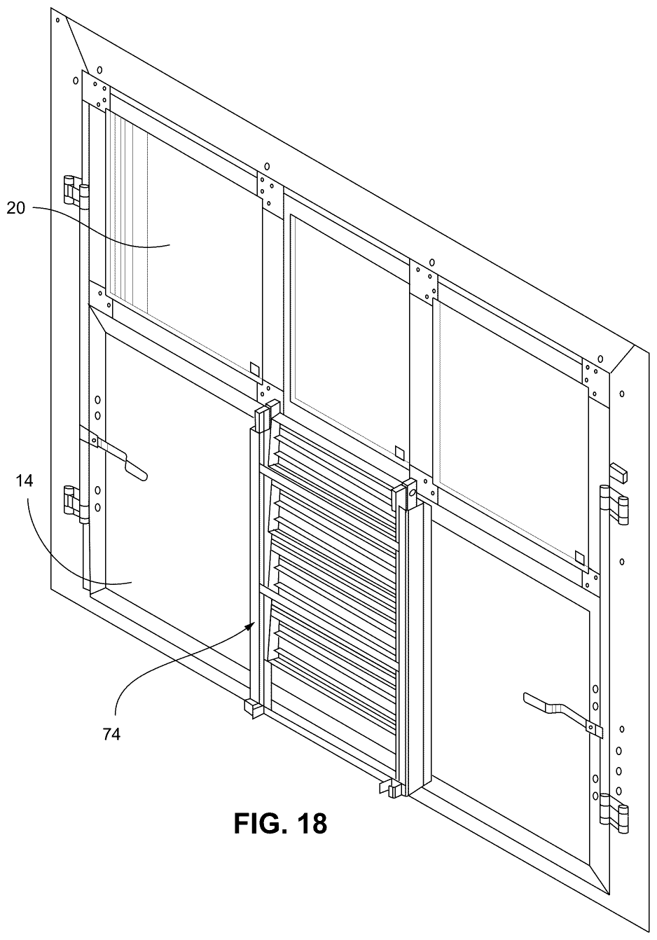

FIGS. 17 and 18 show a variation with the step assembly 74 secured to the balcony floor portion 14. In the variation shown, the step assembly 74 is secured to the bottom of the balcony floor portion 14, and the bottom stringer 78 includes adjustable feet 80 that contact the ground. The step assembly 74 can still be detached or may be stowed flat against the door when it is folded up as shown in FIG. 18.

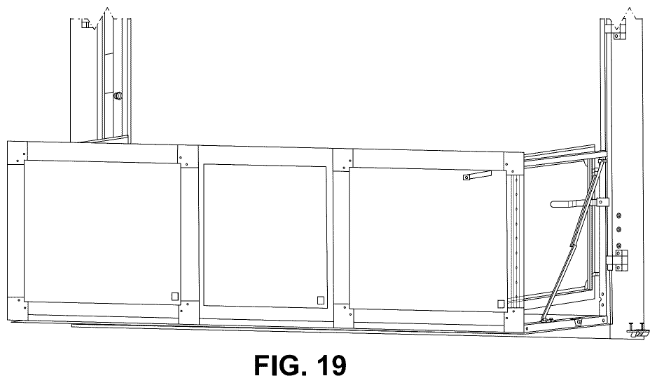

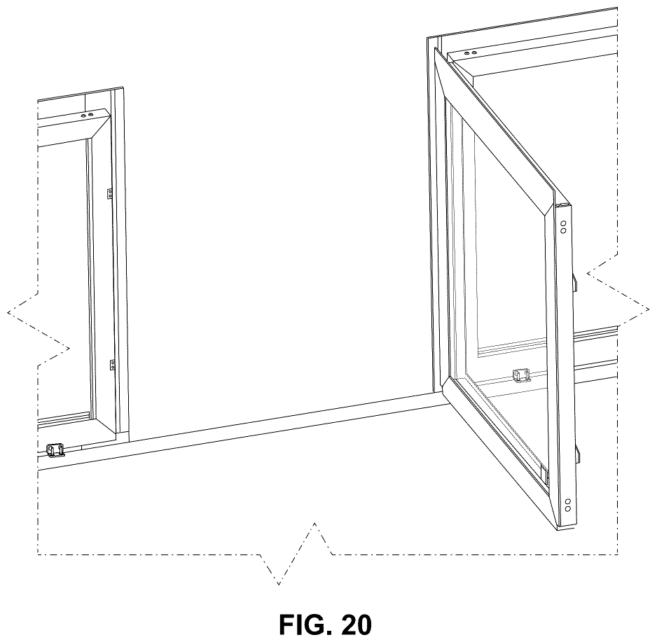

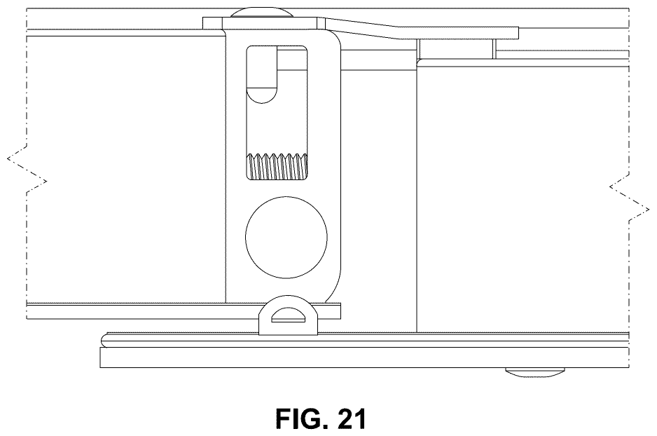

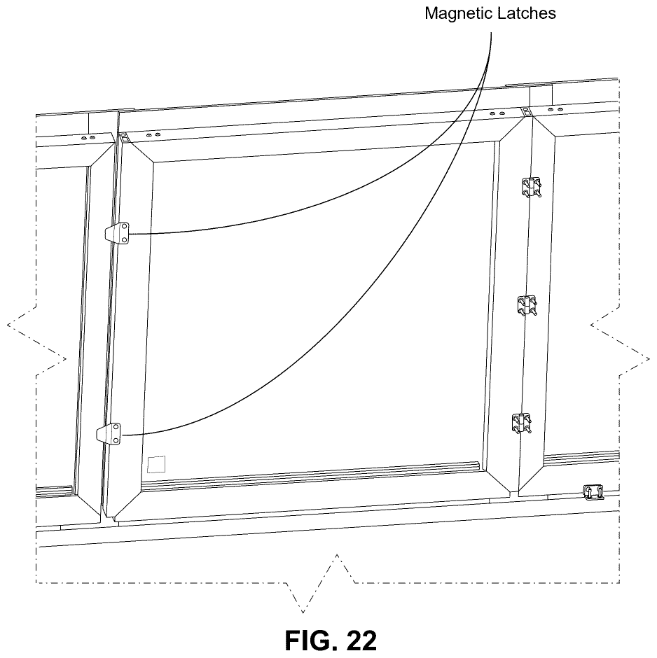

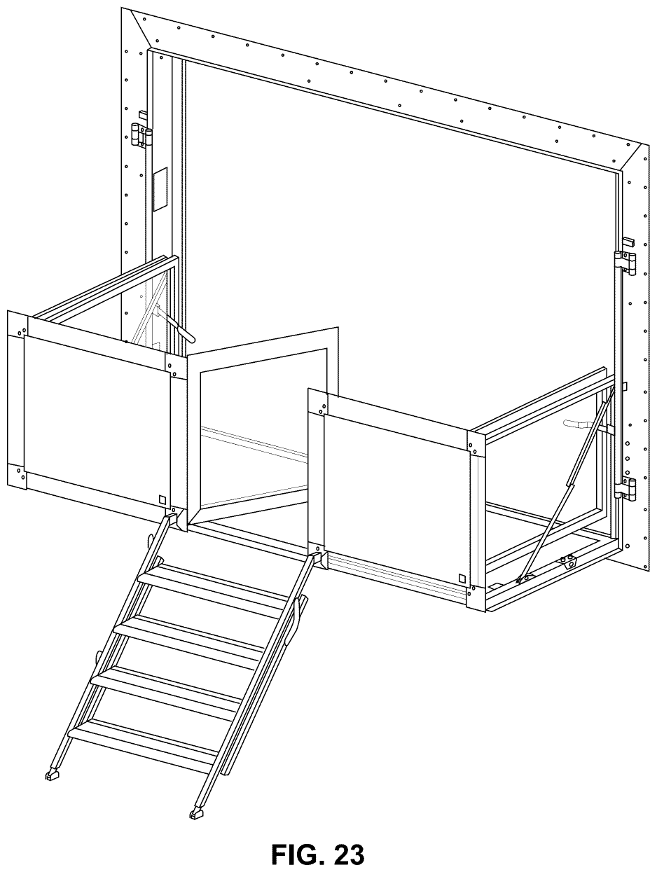

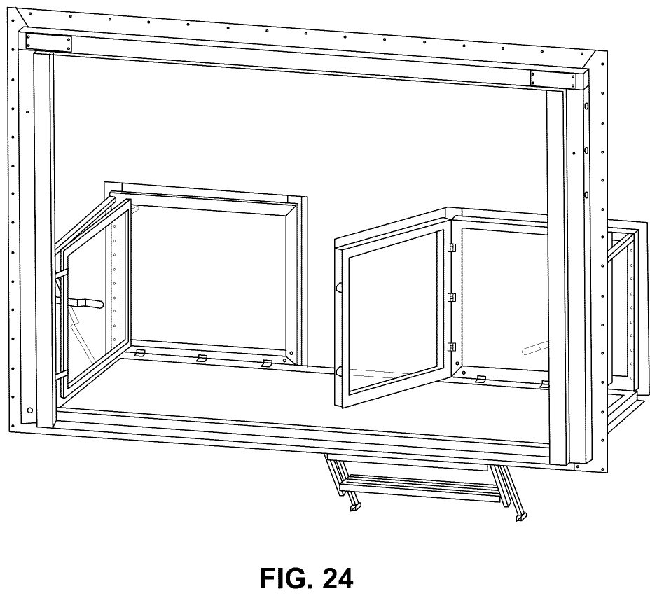

FIGS. 19-24 show variations and features of the bifold balcony.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A bifold balcony for deployment from a side of a vehicle, the bifold balcony comprising:
a balcony floor pivotally connectable at a proximal end to a floor of the vehicle; and
a balcony front wall hingedly connected to a distal end of the balcony floor,
wherein the balcony floor and the balcony front wall are displaceable between a stowed position, in which the balcony floor and the balcony front wall are substantially planar and fixable in a wall opening of the vehicle, and a deployed position, in which the balcony floor is pivoted from the vehicle floor and in which the balcony front wall is pivoted relative to the balcony floor.

2. A bifold balcony according to claim 1, wherein the balcony floor is opaque.

3. A bifold balcony according to claim 1, wherein the balcony front wall comprises a window pane that allows light into the vehicle in the stowed position.

4. A bifold balcony according to claim 1, further comprising a frame jamb positionable in the wall opening of the vehicle, wherein in the stowed position, the balcony floor and the balcony front wall engage the frame jamb.

5. A bifold balcony according to claim 4, further comprising a seal between the frame jamb and the balcony floor and between the frame jamb and the balcony front wall.

6. A bifold balcony according to claim 4, further comprising rotating arm locks actuatable from hinges connected to the frame jamb.

7. A bifold balcony according to claim 6, further comprising a pair of catches disposed on an underside of the balcony floor, wherein the rotating arms locks are respectively engageable with the catches when the balcony floor and the balcony front wall are in the stowed position.

8. A bifold balcony according to claim 4, further comprising a handle disposed on an underside of the balcony floor.

9. A bifold balcony according to claim 4, wherein the frame jamb comprises side jambs, and wherein the bifold balcony further comprises a two-piece folding brace arm including a jamb portion pivotally connected adjacent the side jambs, and a balcony portion pivotally connected to the balcony floor, wherein the jamb portion and the balcony portion are pivotally connected to each other.

10. A bifold balcony according to claim 4, further comprising side barriers disposed between the balcony front wall and the frame jamb in the deployed position.

11. A bifold balcony according to claim 10, wherein each of the side barriers comprises a top rail pivotally connected to the frame jamb such that the top rails are pivotable between a vertical retracted position when the balcony floor and the balcony front wall are in the stowed position and a horizontal extended position when the balcony floor and the balcony front wall are in the deployed position.

12. A bifold balcony according to claim 11, wherein each of the side barriers further comprises a plurality of spring-loaded cables connected between the frame jamb and the balcony front wall.

13. A bifold balcony according to claim 4, further comprising a motor-driven actuation system positioned within the frame jamb and acting on the balcony floor and the balcony front wall to displace the balcony floor and the balcony front wall between the stowed position and the deployed position.

14. A bifold balcony according to claim 1, wherein the balcony front wall comprises a fixed section and a door section pivotally connected to the fixed section, the door section being pivotable relative to the fixed section between a closed position and an open position.

15. A bifold balcony according to claim 14, further comprising a step assembly attachable to a forward portion of the balcony floor in alignment with the door section.

16. A bifold balcony according to claim 15, further comprising stabilizer legs connected to an underside of the balcony floor.

17. A bifold balcony system positionable in a vehicle opening, the bifold balcony system comprising:
a frame jamb securable in the vehicle opening;
a balcony frame including a balcony floor pivotally connectable at a proximal end to a floor of the vehicle and a balcony front wall hingedly connected to a distal end of the balcony floor, wherein the balcony floor and the balcony front wall are displaceable between a stowed position, in which the balcony floor and the balcony front wall are substantially planar and fixable in the frame jamb, and a deployed position, in which the balcony floor is pivoted from the vehicle floor and in which the balcony front wall is pivoted relative to the balcony floor; and
side barriers disposed between the balcony front wall and the frame jamb in the deployed position.

18. A bifold balcony system according to claim 17, wherein the frame jamb comprises side jambs, and wherein the bifold balcony system further comprises a two-piece folding brace arm including a jamb portion pivotally connected adjacent the side jambs, and a balcony portion pivotally connected to the balcony floor, wherein the jamb portion and the balcony portion are pivotally connected to each other.

19. A bifold balcony system according to claim 17, further comprising side barriers disposed between the balcony front wall and the frame jamb in the deployed position.

20. A bifold balcony system according to claim 17, wherein the balcony front wall comprises a fixed section and a door section pivotally connected to the fixed section, the door section being pivotable relative to the fixed section between a closed position and an open position.

21. A bifold balcony system according to claim 20, further comprising a step assembly attachable to a forward portion of the balcony floor in alignment with the door section.

22. A bifold balcony system according to claim 21, further comprising stabilizer legs connected to an underside of the balcony floor.
